(19) United States
(12) Patent Application Publication
(10) Pub. No.: US 2015/0052017 A1
(43) Pub. Date: Feb. 19, 2015

(54) ONLINE STORE ENTITLEMENTS

(71) Applicants: Stefan Wenzel, Heidelberg (DE); Stefan Neumann, Heidelberg (DE)

(72) Inventors: Stefan Wenzel, Heidelberg (DE); Stefan Neumann, Heidelberg (DE)

(73) Assignee: SAP AG, Walldorf (DE)

(21) Appl. No.: 13/970,023

(22) Filed: Aug. 19, 2013

(51) Int. Cl. G06Q 30/06

(52) U.S. Cl. CPC G06Q 30/0617
USPC 705/26.43

(57) ABSTRACT

A system receives input from a seller agent of a first business organization and a centralized purchasing agent of a second business organization. The second business organization includes a plurality of decentralized business departments. The system generates an entitlement for an online purchasing site using the input from the seller agent and the input from the purchasing agent. The entitlement includes a validity condition and an impact condition. The system receives an input from one of the decentralized business departments, examines the validity conditions of the purchased entitlement, and in response to a determination that the validity conditions of the purchased entitlement are met, executes the impact conditions of the selected entitlement.

### TECHNICAL FIELD

The present disclosure relates to online store entitlements.

### BACKGROUND

Existing online store concepts conflict with the characteristics of typical business organizations, and the buying behavior of such business organizations. For example, the buying behavior of a large corporation or other business organization with a centralized purchasing department makes it difficult for its many decentralized departments or business units to easily purchase the goods and services that each of the many decentralized departments needs, such as low value and/or recurring services, solutions, or products.

### BRIEF DESCRIPTION OF THE DRAWINGS

FIGS. 1A, 1B, and 1C are diagrams of an online store entitlement object structure, validity conditions, and impact conditions.

FIG. 2 is a block diagram illustrating operations and features of an online store entitlement system.

FIG. 3 is a block diagram illustrating additional features of the online store entitlement system of FIG. 2.

FIG. 4 is a block diagram of a computer system in connection with which embodiments of the present disclosure can operate.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Online store entitlements address issues and complexities, especially issues and complexities that occur in business organizational buying situations in online stores, and especially in large business organizations that include a centralized purchasing department and many decentralized departments or business units. In an embodiment, the store entitlements enable an online store, online marketplace, or other online entity to sell bundles of small value items or recurring services to decentralized business departments that are associated with a centralized purchasing department via an online store or website. The entitlements enable the implementation of multi-channel concepts by combining offline personal sales channels (such as sales agents and purchasing agents) with online stores. That is, the online entitlements enable a seller agent to provide goods and services to the many business units of a large business organization via these multiple channels that are enabled by the online store entitlements. It is noteworthy that online store entitlements go beyond the capabilities of classical “coupons” or “voucher” concepts in that as illustrated in the examples below, they can flexibly define their domain of validity to product or service groups, time frames, target audiences, and their impact on prices or payment terms.

More specifically, online store entitlements are products themselves, listed as such in an online store. They can be searched for, reviewed, and purchased by customers like any other product. An example difference however between an online store entitlement and a normal product is that by purchasing a store entitlement, a customer is purchasing the right to retrieve other solutions, products, or services without an additional charge, or for a certain discount for a certain period of time.

An online store entitlement is in principle a set of purchasing conditions. These conditions can be grouped into “Validity Conditions” and “Impact Conditions.” Validity conditions define which conditions need to be “True” in order to use the purchased entitlement. “Impact Conditions” define which impact the entitlement has when using it for a certain purchase. The provider/seller (e.g., seller agent) of the entitlement can freely define these conditions. Validity conditions can include such things as products (also solutions or services); product, service, and solution types or groups; entitlement quantities per product, solution, service, or the respective types; date or time frame; and job title or role. Impact conditions can include such things as price (e.g., reduction to zero, application of percentage discount), payment terms (e.g., deferred payments), service level (e.g., 24 hour phone support), and delivery conditions (e.g., premium delivery).

In an embodiment, online store entitlements can effectively counter the issues relating to existing online store concepts that conflict with the characteristics of organizational buying behavior. For example, by purchasing entitlements, the multiple small requirements of a large business organization, and in particular the small requirements of the many business units of the large business organization, can be bundled into one object. This object, or the entitlement, can more easily be considered for purchase by a large business organization in its standard long term purchasing and acquisition processes. Small value items only of interest for a single business owner (or a single department in a large corporation) often would be dropped or completely missed in typical purchasing or acquisition processes of a large business organization. The entitlement however helps to avoid this.

As noted, since purchasing departments are often centralized, raising demand for small value and recurring items is a large barrier for business departments. With online store entitlements however, purchasing authority can be transferred from central purchasing departments to decentralized business departments without having to deal with or modify the corporate purchasing policies. Such a scenario addresses the issue that while central purchasing departments have an advantage of bundling purchasing power, these same central departments have a disadvantage of being entrenched and inflexible. With online store entitlements, this situation can be overcome. That is, the store entitlements can be centrally purchased by the central purchasing department, which permits the exercise of bundled purchasing power, and the store entitlements can also be used to decentrally purchase concrete solutions and products needed by the many decentralized business units of the business organization. In a similar manner, online store entitlements can address issues with the purchase or recurring goods as they are needed, since such recurring purchases often conflict with the long term budgeting plans of a company. Specifically, budgets are normally established on a quarterly basis. This can often lead to higher costs for the recurring purchases. In short, store entitlements enable solid plans with demand oriented purchasing.

An online store entitlement can have one or more quantity parameters defined separately or in correlation to another validity parameter. These quantity parameters define how often an entitlement can be used. Additionally, certain dates or values can be used to restrict usage of quantities or the entitlements themselves. As noted, the store entitlements are an instrument to counter certain barriers appearing when using online sales channels in business-to-business (B2B) environments. Specifically, organizational buying behavior is characterized by decisions made by groups (e.g., purchasing departments or so called buying centers); □ formalized, long lasting, and difficult-to-change processes; □ centralized purchasing departments versus decentralized business departments; and fixed budgets for a certain planning period.

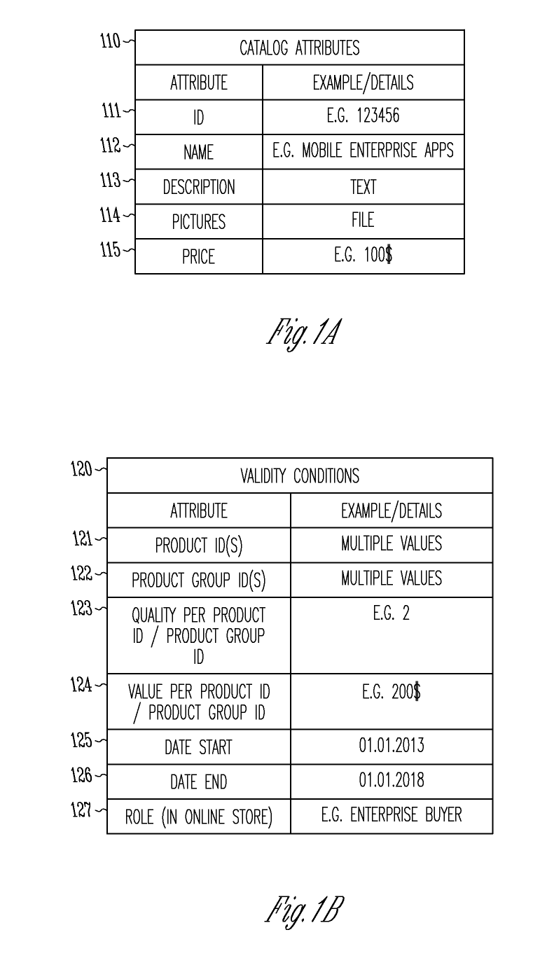

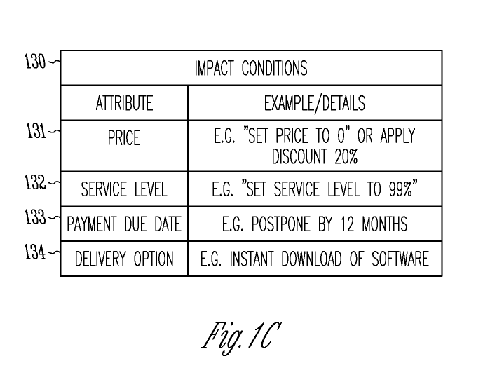

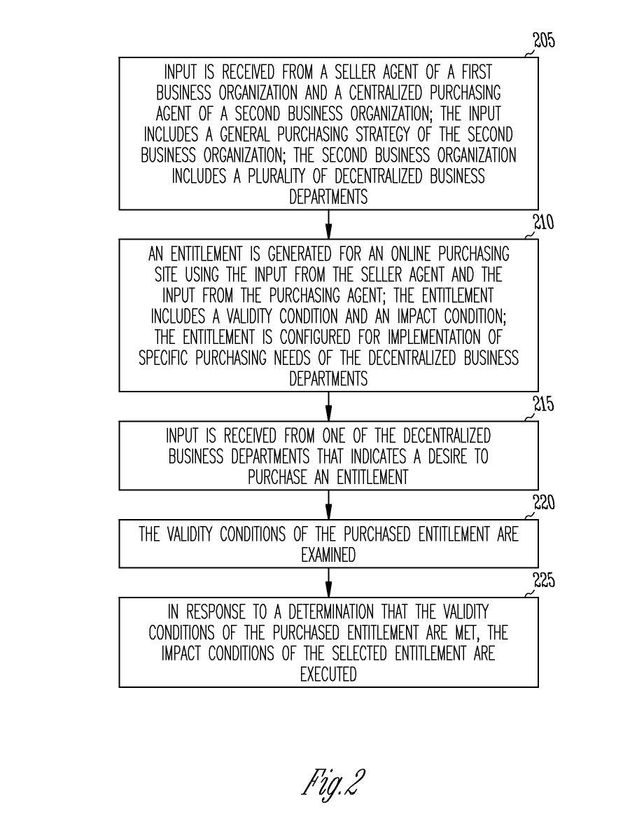

The store entitlement is a separate object in the respective online store and consists mainly of three structural elements as illustrated in FIGS. 1A, 1B, and 1C. It is noted that FIGS. 1A, 1B, and 1C only give an example of the available parameters, names, etc. Those of skill in the art will know of other parameters to make use of in one or more embodiments. The catalog attributes 110 describe the store entitlement as a normal product in an online store. In the example of FIG. 1A, the attributes include an identification (ID) 111 (of the product or service), a name (of the product or service) 112, a description (of the product or service) 113, a picture (of the product itself or something associated with the service) 114, and a price 115. As illustrated in the example of FIG. 1A, the entitlement can relate to a group of mobile enterprise applications for use on mobile devices. The description 113 would then contain a description of each of the different mobile apps associated with this entitlement. The pictures 114 could contain several screen shots that illustrate the features of the several mobile apps, and the price 115 indicates the price for the online store entitlement (which includes all of the several mobile apps).

FIG. 1B illustrates validity conditions 120 that are logical expressions which combine one to many attributes and values by using logical operators such as “OR”,“XOR”, “AND”, “NOT”. The example of FIG. 1B illustrates that the validity conditions 120 can include product IDs 121, product group IDs 122, the quantity per product ID or product group ID 123, the value per product ID or product group ID 124, a start date 125, an end date 126, and a role 127. For example, the product IDs 121 can include all of the products for all of the many catalog attribute IDs 111. The product group IDs 122 group all of these products into categories. For example, the mobile apps of FIG. 1A may be grouped into a software product group ID. The quantity per product or product group 123 can indicate for example that there are five mobile applications in the mobile enterprise application entitlement. The value 124 would then indicate the value of these five mobile apps. The start date 125 and end date 126 indicate the date range in which the entitlement is available, and the role 127 indicates the role of a prospective purchaser of the entitlement, such as an enterprise buyer as illustrated in FIG. 1B.

FIG. 1C illustrates that the impact condition 130 is also a logical expression combining one or multiple individual statements with logical operators. The example of FIG. 1C illustrates if the relevant validity conditions are “True”, the conditions that are impacted are the price 131, the service level 132, the payment terms 133, and the delivery means 134.

The validity conditions and the impact conditions are then both combined in an “If . . . then . . . ” statement in combination with one or more logical operators such as “OR”, “XOR”, “AND”, “NOT”. For example, a statement may be “If (product type=software) AND value is greater than $500 then (price=price*0.5 AND service level=99%). This statement means that if this entitlement is purchased, the customer could purchase all software products on the online store for half of the price.

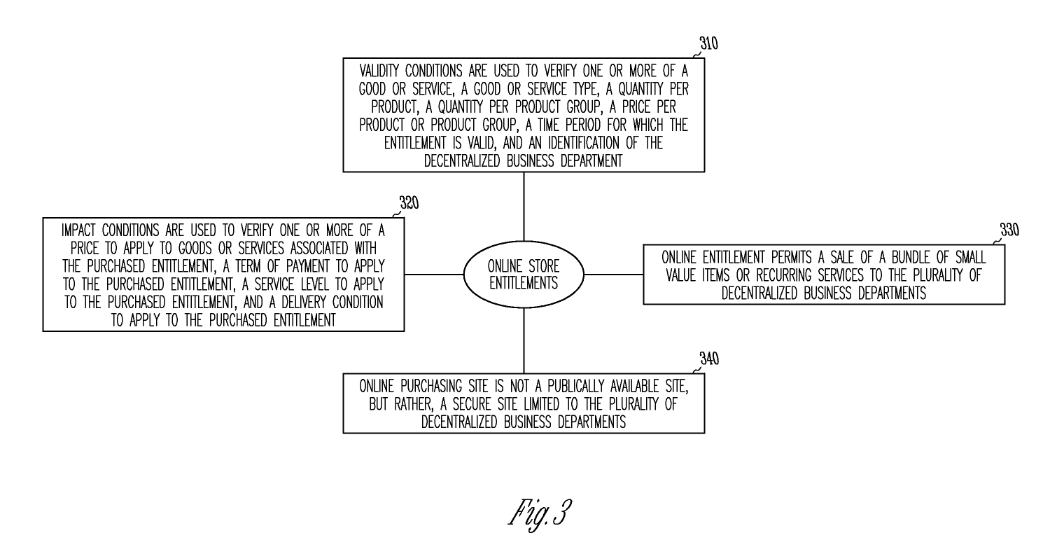

FIG. 2 is a block diagram illustrating operations and features of an online store entitlement system. FIG. 2 includes a number of operation and process blocks 205-225. Though arranged serially in the example of FIG. 2, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 2, at 205, input is received from a seller agent of a first business organization and a centralized purchasing agent of a second business organization. The input includes a general purchasing strategy of the second business organization. This general purchasing strategy could include such information as in the current calendar quarter, two million dollars will be spent on software and four millions dollars will be spent on hardware. The general purchasing strategy could further include that out of the two million software dollars, one million is reserved for mobile applications, and out of the four million for hardware, one million is reserved for mobile devices. The second business organization includes a plurality of decentralized business departments. At 210, an entitlement is generated for an online purchasing site using the input from the seller agent and the input from the purchasing agent. The entitlement includes a validity condition and an impact condition. The entitlement is configured for implementation of specific purchasing needs of the decentralized business departments. For example, if a large energy company has a petroleum division, and that petroleum division has an oil exploration division, then the oil exploration division may have a specific purchasing need for geological-related mobile applications. In an embodiment, the online purchasing site is managed by the first business organization. For example, the first business organization that is attempting to sell its products to the second business organization makes this online purchasing site available to its customers (such as the second business organization). In a more specific embodiment, access to the online purchasing site is limited to the plurality of decentralized business departments of the second business organization.

At 215, input is received from one of the decentralized business departments that indicates a desire to purchase an entitlement. For example, the oil exploration division of the petroleum corporation can purchase the entitlement related to geological-type mobile applications. At 220, the validity conditions of the purchased entitlement are examined. At 225, in response to a determination that the validity conditions of the purchased entitlement are met, the impact conditions of the selected entitlement are executed. As noted above, it is at operations 220 and 225 wherein if certain validity conditions are met (for example, price of each mobile app is greater than $500), that certain impact conditions are implemented (for example, a 20% discount is applied to the price).

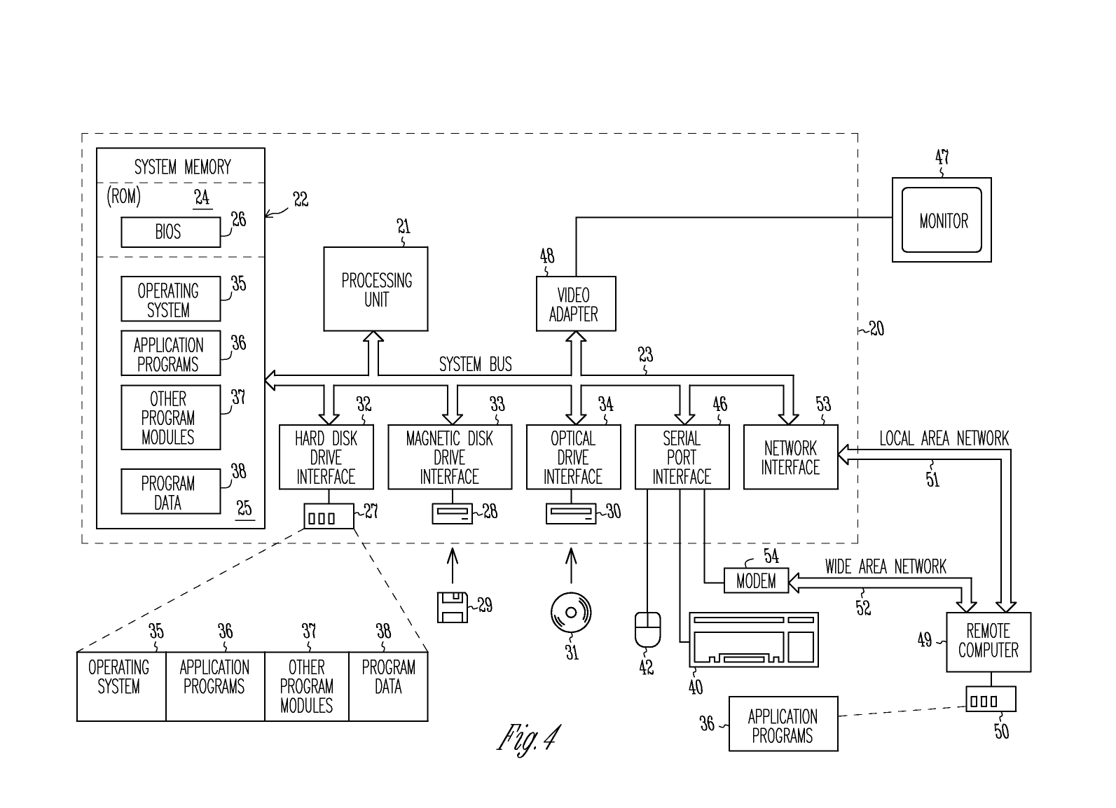

FIG. 3 is a block diagram that illustrates several additional features of the online store entitlement of FIG. 2. Block 310 illustrates that the validity conditions, as discussed above, are used to verify one or more of a good or service, a good or service type, a quantity per product, a quantity per product group, a price per product or product group, a time period for which the entitlement is valid, and an identification of the decentralized business department. Block 320 illustrates that the impact conditions, as discussed above, are used to verify one or more of a price to apply to goods or services associated with the purchased entitlement, a term of payment to apply to the purchased entitlement, a service level to apply to the purchased entitlement, and a delivery condition to apply to the purchased entitlement. Once again, the features of blocks 310 and 320 are just examples, and other features can be used in other situations. Block 330 indicates that the online entitlement permits a sale of a bundle of small value items or recurring services to the plurality of decentralized business departments. For example, the geological-related mobile apps may be a relatively small purchase for the energy company, but the entitlement allows the bundling of these several geological-related apps into an entitlement for a single purchase decision by the decentralized oil exploration division and consideration of the validity conditions and execution of the impact conditions for the purchase of the entitlement. Block 340 shows that the online purchasing site is not a publically available site, but rather, a secure site limited to the plurality of decentralized business departments. Such a site would normally be constructed, offered, and maintained by the seller agent.

FIG. 4 is an overview diagram of hardware and an operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 47 can display a graphical user interface for the user. In addition to the monitor 47, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

It should be understood that there exist implementations of other variations and modifications of the invention and its various aspects, as may be readily apparent, for example, to those of ordinary skill in the art, and that the invention is not limited by specific embodiments described herein. Features and embodiments described above may be combined with each other in different combinations. It is therefore contemplated to cover any and all modifications, variations, combinations or equivalents that fall within the scope of the present invention.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
a computer processor operable to:
receive input from a seller agent of a first business organization and a centralized purchasing agent of a second business organization, the input comprising a general purchasing strategy of the second business organization, wherein the second business organization comprises a plurality of decentralized business departments;
generate an entitlement for an online purchasing site using the input from the seller agent and the input from the purchasing agent, the entitlement comprising a validity condition and an impact condition, the entitlement configured for implementation of specific purchasing needs of the decentralized business departments, the online purchasing site managed by the first business organization, wherein access to the online purchasing site is limited to the plurality of decentralized business departments;
receive an input from one of the decentralized business departments purchasing the entitlement;
examine the validity conditions of the purchased entitlement; and
in response to a determination that the validity conditions of the purchased entitlement are met, execute the impact conditions of the selected entitlement.

2. The system of claim 1, wherein the validity conditions are operable to verify one or more of a good or service, a good or service type, a quantity per product, a quantity per product group, a price per product or product group, a time period for which the entitlement is valid, and an identification of the decentralized business department.

3. The system of claim 1, wherein the impact conditions are operable to verify one or more of a price to apply to goods or services associated with the purchased entitlement, a term of payment to apply to the purchased entitlement, a service level to apply to the purchased entitlement, and a delivery condition to apply to the purchased entitlement.

4. The system of claim 1, wherein the online entitlement permits a sale of a bundle of small value items or recurring services to the plurality of decentralized business departments.

5. The system of claim 1, wherein the online purchasing site is a secure site, wherein access is limited to the plurality of decentralized business departments, and wherein access is not permitted to the general public.

6. A system comprising:
a computer processor operable to:
receive input from a seller agent of a first business organization and a centralized purchasing agent of a second business organization, the input comprising a general purchasing strategy of the second business organization, wherein the second business organization comprises a plurality of decentralized business departments;
generate an entitlement for an online purchasing site using the input from the seller agent and the input from the purchasing agent, the entitlement comprising a validity condition and an impact condition, and the entitlement configured for implementation of specific purchasing needs of the decentralized business departments;
receive an input from one of the decentralized business departments purchasing the entitlement;
examine the validity conditions of the purchased entitlement; and
in response to a determination that the validity conditions of the purchased entitlement are met, executing the impact conditions of the selected entitlement.

7. The system of claim 6, wherein the online purchasing site is managed by the first business organization, and wherein access to the online purchasing site is limited to the plurality of decentralized business departments.

8. A process comprising:
receiving input from a seller agent of a first business organization and a centralized purchasing agent of a second business organization, the input comprising a general purchasing strategy of the second business organization, wherein the second business organization comprises a plurality of decentralized business departments;
generating an entitlement for an online purchasing site using the input from the seller agent and the input from the purchasing agent, the entitlement comprising a validity condition and an impact condition, the entitlement configured for implementation of specific purchasing needs of the decentralized business departments, the online purchasing site managed by the first business organization, wherein access to the online purchasing site is limited to the plurality of decentralized business departments;
receiving an input from one of the decentralized business departments purchasing the entitlement;
examining the validity conditions of the purchased entitlement; and
in response to a determination that the validity conditions of the purchased entitlement are met, executing the impact conditions of the selected entitlement.

9. The process of claim 8, wherein the validity conditions are operable to verify one or more of a good or service, a good or service type, a quantity per product, a quantity per product group, a price per product or product group, a time period for which the entitlement is valid, and an identification of the decentralized business department.

10. The process of claim 8, wherein the impact conditions are operable to verify one or more of a price to apply to goods or services associated with the purchased entitlement, a term of payment to apply to the purchased entitlement, a service level to apply to the purchased entitlement, and a delivery condition to apply to the purchased entitlement.

11. The process of claim 8, wherein the online entitlement permits a sale of a bundle of small value items or recurring services to the plurality of decentralized business departments.

12. The process of claim 8, wherein the online purchasing site is a secure site, wherein access is limited to the plurality of decentralized business departments, and wherein access is not permitted to the general public.

13. A computer readable medium comprising instructions that when executed by a processor execute a process comprising:
receiving input from a seller agent of a first business organization and a centralized purchasing agent of a second business organization, the input comprising a general purchasing strategy of the second business organization, wherein the second business organization comprises a plurality of decentralized business departments;
generating an entitlement for an online purchasing site using the input from the seller agent and the input from the purchasing agent, the entitlement comprising a validity condition and an impact condition, the entitlement configured for implementation of specific purchasing needs of the decentralized business departments, the online purchasing site managed by the first business organization, wherein access to the online purchasing site is limited to the plurality of decentralized business departments;
receiving an input from one of the decentralized business departments purchasing the entitlement;
examining the validity conditions of the purchased entitlement; and
in response to a determination that the validity conditions of the purchased entitlement are met, executing the impact conditions of the selected entitlement.

14. The computer readable medium of claim 13, wherein the validity conditions are operable to verify one or more of a good or service, a good or service type, a quantity per product, a quantity per product group, a price per product or product group, a time period for which the entitlement is valid, and an identification of the decentralized business department.

15. The computer readable medium of claim 13, wherein the impact conditions are operable to verify one or more of a price to apply to goods or services associated with the purchased entitlement, a term of payment to apply to the purchased entitlement, a service level to apply to the purchased entitlement, and a delivery condition to apply to the purchased entitlement.

16. The computer readable medium of claim 13, wherein the online entitlement permits a sale of a bundle of small value items or recurring services to the plurality of decentralized business departments.

17. The computer readable medium of claim 13, wherein the online purchasing site is a secure site, wherein access is limited to the plurality of decentralized business departments, and wherein access is not permitted to the general public wherein the online purchasing site is a secure site, wherein access is limited to the plurality of decentralized business departments, and wherein access is not permitted to the general public.
